(19) United States
(12) Patent Application Publication
(10) Pub. No.: US 2006/0272306 A1
(43) Pub. Date: Dec. 7, 2006

(54) Ceramic wall flow filter manufacture

(76) Inventors: Brian Scott Kirk, Corning, NY (US); Dominick Madaffari JR., Corning, NY (US); Steven Bolaji Ogunwumi, Painted Post, NY (US); Robert John Paisley, Corning, NY (US); Brian Paul Usiak, Painted Post, NY (US)

Correspondence Address: CORNING INCORPORATED, SP-TI-3-1, CORNING, NY, 14831, US

(21) Appl. No.: 11/186,466

(22) Filed: Jul. 20, 2005

Related U.S. Application Data
(60) Provisional application No. 60/686,497, filed on Jun. 1, 2005.

(51) Int. Cl. B01D 46/00

(52) U.S. Cl. 55/523

(57) ABSTRACT

Porous ceramic wall flow filter bodies of unitary or segmented construction wherein the honeycomb channels are alternately plugged with plugging cements incorporating low expansion refractory fillers and permanent inorganic bonding agents, the latter imparting improved plug integrity and plug bonding to the porous ceramic honeycomb channel walls.

This application claims the benefit of U.S. Provisional Application No. 60/686,497, filed Jun. 1, 2005, entitled “Ceramic Wall Flow Filter Manufacture”, by S. Ogunwumi et al.

### BACKGROUND OF THE INVENTION

The present invention relates to the manufacture of porous ceramic particulate filters, and more particularly to improved materials and processes for sealing selected channels of porous ceramic honeycombs to form wall-flow ceramic filters therefrom.

Ceramic wall flow filters are finding widening use for the removal of particulate pollutants from diesel or other combustion engine exhaust streams. A number of different approaches for manufacturing such filters from channeled honeycomb structures formed of porous ceramics are known. The most widespread approach is to position cured plugs of sealing material at the ends of alternate channels of such structures which can block direct fluid flow through the channels and force the fluid stream through the porous channel walls of the honeycombs before exiting the filter. Illustrative of this approach is U.S. Pat. No. 6,809,139, which describes the use of sealing materials comprising cordierite-forming (MgO—Al₂O₃—SiO₂) ceramic powder blends and thermosetting or thermoplastic binder systems to form such plugs.

Among the problems attending the manufacture of plugged ceramic filter products is that of insuring plug integrity and durability. Many of the known plugging methods involve the use of plugging compositions that must be fired to relatively high temperatures to properly cure the plugging material and cause it to bond firmly to the porous channel walls of the structure. Other methods involve the use of “cold set” cements that are not set through high temperature firing, and which thus may not exhibit sufficient strength and durability at the high temperatures and pressures found in combustion engine exhaust systems.

Other requirements for successful plugging materials include a relatively low coefficient of thermal expansion (CTE) for physical compatibility with the filter material, and stability in the presence of the water vapor typically present in combustion engine exhaust streams. Low thermal expansion is required to enable the cured plugs to resist thermal stress cracking of the plug or the channel walls of the ceramic honeycomb, and to remain bonded to the channel walls under repeated thermal cycling. Some previous plugging mixtures produce cured cements that have dramatically higher thermal expansion coefficients than the fired ceramic material of the channel walls. With repeated thermal cycling a plug-channel CTE mismatch can lead to separation at the plug/matrix interface or cracking at the face of the filter.

Moisture stability is needed to avoid chemical changes in the plugging material in the engine exhaust environment that could undesirably alter the physical or chemical characteristics of the plug. Plug physical and chemical stability providing strong long-term adhesion between the plugging material and honeycomb ceramic is of course essential to maintain the integrity of the plug-channel seal for the life of the wall flow filter.

### SUMMARY OF THE INVENTION

In accordance with the present invention there is provided a family of plugging mixtures for ceramic wall flow filters that solves the problems of poor physical and chemical compatibility with common wall flow filter materials, and that provides plugs exhibiting good physical and chemical stability in the moist, high-stress environment of a wall flow engine exhaust filter. Thus plugs formed from these mixtures provide a stable, well-bonded and long-term seal with such wall flow filter materials.

In another aspect of the invention there is provided a porous ceramic wall flow filter body incorporating cured plugs in selected channels of the filter body, the plugs being well matched physically and chemically with the wall flow filter material and forming durable permanent seals with the channel walls of the body.

The plugging mixtures provided in accordance with the invention comprise (a) a low-expansion refractory filler; (b) a permanent inorganic bonding agent; (c) a liquid vehicle, and (d) a vehicle-soluble temporary binder. The low-expansion refractory filler is important to assure physical compatibility with the wall flow filter material, while the permanent inorganic bonding agent acts to consolidate and toughen the seal as well as to bond and seal the refractory filler to the porous channel walls. While the preferred vehicle is water and the preferred temporary binders are water-soluble binders, alcohol-based, petroleum-based, or other types of vehicles can be substituted and a temporary binder soluble in that vehicle instead employed.

The porous ceramic wall flow filter body of the invention thus consists of a channeled honeycomb body wherein selected channels incorporate plugs permanently sealed to the porous channel walls. The plugs exhibit improved chemical and physical compatibility with the wall flow filter material, comprising both a low-expansion refractory filler and a permanent inorganic bonding agent for consolidating the refractory filler into unitary plugs and sealing the plugs to the porous channel walls.

### DETAILED DESCRIPTION

Conventional porous ceramic materials currently being considered for the manufacture of wall flow ceramic filters include ceramics such as cordierite, silicon carbide, silicon nitride, aluminum titanate, beta-eucryptite, and beta-spodumene. In some cases these ceramics are formed in situ via reactive sintering of a preform for a channeled honeycomb body; in other cases powders of the ceramics themselves are simply sintered together to produce a porous honeycomb of the required porosity and strength. Where the wall flow filters are low-expansion filters, i.e. filters formed of low-thermal-expansion ceramics such as reaction-sintered cordierite and aluminum titanate that have coefficients of thermal expansion below about 25×10⁻⁷/° C. as measured at 1000° C., they can be provided either as unitary honeycomb structures, or if desired as bonded honeycomb assemblies. Where the honeycombs are formed of higher expansion ceramics such as silicon carbide, bonded honeycomb assemblies are normally required.

The low expansion refractory fillers making up the bulk of the plugging mixtures of the invention may be introduced into the plugging mixture in any convenient form; examples of suitable forms include powders, small agglomerates, ceramic fibers or the like. In preferred cement embodiments the low expansion refractory filler will be a pre-reacted amorphous or crystalline ceramic powder that is not significantly changed in composition or structure at plug curing or filter use temperatures. This avoids the need to use high curing temperatures to chemically react the plug constituents, and it also insures that the low thermal expansion characteristics of the refractory filler will not be lost during curing or in use.

To improve the chemical and physical compatibility of the seals with the porous ceramic materials used to fabricate the honeycombs, fillers having average coefficients of thermal expansion not exceeding about 30×10⁻⁷/° C. (25-800° C.) should be used. Preferably, the difference between the coefficient of thermal expansion of the honeycomb and the coefficient of thermal expansion of the cured seal should not exceed about 20×10⁻⁷/° C. (25-800° C.) Further, for chemical compatibility with such materials, the fillers will either be similar in composition to the composition of the honeycombs, or else thermally stable and relatively inert in contact with the honeycombs and with the permanent inorganic bonding agent under the conditions of use.

Examples of suitable refractory fillers having expansion coefficients reasonably well matched to those of common wall flow filter materials include powders of silicon carbide, silicon nitride, cordierite, aluminum titanate, calcium aluminate, beta-eucryptite, and beta-spodumene, as well as refractory aluminosilicate fibers formed, for example, by the processing of aluminosilicate clay.

The permanent inorganic bonding agent provided in the plugging mixtures of the invention generally consists of or is derived from a colloidal or finely divided silica or silicate material, typically of no or low organics content. Such materials are easily and thoroughly dispersible in the plugging mixtures of the invention such that they can provide both effective consolidation of the refractory fillers and good sealing to the channel walls of the ceramic honeycomb structure.

It is important that the silica permanent inorganic bonding agent be a finely divided silica in order to impart the necessary bonding effectiveness at relatively low curing temperatures. Sand and other coarse silica materials are not sufficiently reactive for this purpose. By finely divided silica is meant silica having a maximum average particle size not exceeding about 0.5 micrometers.

Examples of suitable silica or silicate materials for use as bonding agents include silica sols and powdered silica or silicate glasses. One potential advantage of silicate-glass-bonded filler plugs is that the silicate (glass) can be selected to “soften” during peak temperature of regeneration and thus “relieve” any stresses which may have built up within the plugs or filter during use.

The use of these bonding agents is important for securing adequate plug strength and sealing with the porous channel walls of the ceramic honeycomb filter structure. Thus the plugs must not only have physical properties that include a coefficient of thermal expansion close to that of the honeycomb material, but also strength and adhesion to the honeycomb walls that are great enough to withstand the pressure gradients created by the hot exhaust gas flows. Examples of specific target properties for plugs exhibiting good physical compatibility and sealing performance when employed for the manufacture of low-expansion ceramic honeycomb filters are the following:

| | |
|---|---|
| Modulus of rupture strength (bar bending) | >500 psi |
| Linear coefficient of thermal expansion (×10⁻⁷/° C., | ≦30 |
| 800°-25° C. cooling) | |
| Plug pushout failure force | >6 lbf |

The preferred vehicle for providing a flowable or paste-like consistency to these plugging mixtures is water, although as mentioned other liquid vehicles exhibiting solvent action with respect to suitable temporary binders can be used. Suitable temporary binders for use in plugging mixtures incorporating the preferred water vehicle include water soluble cellulosic binders, typically cellulose derivatives such as the cellulose ethers. Particular examples include methyl cellulose and hydroxypropyl methyl cellulose.

The relative proportions of refractory filler and inorganic bonding agent provided in the plugging mixtures of the invention will vary depending upon the selection of the filler and the processing to be employed to consolidate the filler into unitary plugs and seal the plugs to the channel walls of the filter. The weight ratio of bonding agent to filler is generally in the range from as low as 1:20 to as high as 2:3. Lower proportions of the bonding agent can result in inadequate plug consolidation or poor sealing to the channel walls, while excessive bonding agent additions can decrease plug refractoriness as well as reduce physical and chemical plug compatibility with porous ceramic channel walls.

The plugging mixtures of the invention are useful in plugging processes employing “cold set” plugs as well as in processes where the plugs are heat-cured. In cold-set plugging, only drying of the plugging mixture is required to form a seal with the channel walls of the honeycombs. Heating of the plugged honeycombs to temperatures in the 35-110° C. range can be useful to accelerate drying. In some cold-set plugging processes it is anticipated that final plug consolidation, including the removal of residual temporary binder by-products and strengthening of the seals, can even occur the course of subsequent processing of the filter (in the course of catalyzation or canning) or during first use of the filter in an exhaust system.

Where heat-curing of the plugs is to be employed, curing temperatures will generally range from those temperatures at least effective to remove temporary binders and optional organic lubricants and plasticizers, to higher curing temperatures at which activation of the bonding agent to consolidate the refractory filter and seal the unitary plugs to the channel walls of the honeycombs can be completed. Temperatures ranging up to about 1000° C. are typically more than sufficient to heat-cure even the most refractory of the plugging mixtures hereinabove described.

The plugging mixtures of the invention may additionally comprise minor optional additions of other components for purposes such as improving temporary binder effectiveness or modifying the plasticity or lubricity of the mixture to improve its compatibility with conventional plugging processes. Examples of suitable optional additives include plasticizing agents such as the polyvinyl butyral resin plasticizers and lubricating agents such as mineral oils. In general the total proportions of these optional additives will not exceed about 10% by weight of the final plugging mixture.

The invention may be further understood by reference to the following examples, which are intended to be illustrative rather than limiting.

### Example 1

### Fiber-Containing Plugging Mixtures and Cements

A plugging mixture suitable for the plugging of selected channels of silicon carbide extruded segments to be assembled into a porous ceramic wall flow filter body is compounded from a refractory filler mixture of aluminosilicate fibers, aluminum titanate powder, and calcium aluminate powder, the mixture having a composition, in percent by weight, as reported in Table 1A below:

TABLE 1A
Silicon Carbide Segmented Filter Plugging Mixture

| | |
|---|---|
| Refractory fillers | 4.9% Kaowool ® aluminosilicates fibers; |
| | 9.8% aluminum titanate powder; |
| | 9.8% calcium aluminate powder; |
| | 29.4.% silicon carbide powder |
| Permanent binder | 6.9% silica sol |
| Temporary binder | 0.98% methyl cellulose |
| Vehicle | 38.22% water |

These constituents are blended into a homogenous paste and the resulting paste then injected into the ends of selected channels of the silicon carbide honeycomb segments. The same paste is also applied between multiple selectively plugged segments to form a bundle of segments joined by paste layers. The thus provided bundle of selectively plugged segments is thereafter heated to 110° C. for a time sufficient to dry and partially cure the plugs and bonding cement, thus to provide a bonded, selectively plugged silicon carbide wall flow filter body.

A similar plugging mixture of substantially the same composition as above, but wherein the silicon carbide refractory filler powder is replaced by the same weight of silicon nitride powder, can be used in the same manner to form a bonded, selectively plugged wall flow filter body wherein extruded honeycomb segments of silicon nitride form the honeycomb structure of the filter.

A modified plugging mixture of similar composition but from which the silicon carbide filler powder has been omitted can be used to selectively plug a unitary ceramic honeycomb structure wherein the porous ceramic channel walls are formed of aluminum titanate. A representative example of a suitable plugging mixture is reported in Table 1B below, the composition being reported in parts by weight of the mixture:

TABLE 1B
Aluminum Titanate Unitary Filter Plugging Mixture

| | |
|---|---|
| Refractory fillers | 13.9% aluminum titanate; |
| | 13.9% calcium aluminate; |
| | 6.94% Kaowool ® aluminosilicates fibers |
| Permanent binder | 9.77% Silica Sol |
| Temporary binder | 1.39% Methyl Cellulose |
| Vehicle | 54.1% water |

Again, only mild heating of the plugged aluminum titanate filter body to a temperature of about 110° C. is needed to dry and initially set and bond the plugging mixture to the porous ceramic walls of the honeycomb channels.

### Example 2

### Powder-Filled Plugging Mixtures

For high-temperature diesel exhaust filtration applications where severe filter regeneration procedures will be used repeatedly to removed trapped carbonaceous particulates from the filters by combustion, plugging mixtures based on pre-sintered (pre-reacted) refractory ceramic powders exhibiting low thermal expansion characteristics can offer improved thermal compatibility and chemical stability. Plugging mixtures based on pre-reacted cordierite or aluminum titanate powders offer a good combination of low thermal expansion and high-temperature stability, and can provide plugs exhibiting superior strength and sealing characteristics when used in combination with a suitable permanent bonding agent in accordance with the invention. Moreover, such plugging mixtures can be used with any of the low-expansion porous ceramic filter materials, including for example cordierite and aluminum titanate materials, without particular regard for whether the refractory powder filler employed is from the same or a different family of ceramic composition. That is because these powders are substantially inert at the temperatures to be encountered by the filters in actual use.

Examples of three plugging mixtures useful for the plugging of cordierite or aluminum titanate ceramic honeycomb structures are reported in Table 2 below. The compositions reported in Table 2 are reported in percent by weight, exclusive of the water vehicle added to the mixtures:

TABLE 2
Pre-Reacted Powder Plugging Mixtures

| | Mixture A | | Mixture B | | Mixture C | |
|---|---|---|---|---|---|---|
| Refractory filler | Cordierite | 63.5% | Cordierite | 93% | Aluminum | 79.1% |
| | powder | | powder | | titanate powder | |
| Permanent Bonding | Ludox ® colloidal | 19.8% | Silbond H-4 | 6% | Ludox ® | 19.7% |
| Agent(s) | silica | | silicate resin | | colloidal silica | |
| | Glass powder* | 15.9% | | | | |
| Temporary Binder | Methocel ® | 0.8% | Methocel ® | 0.8% | Methocel ® | 1.2% |
| | cellulose ether | | cellulose ether | | cellulose ether | |
| Optional plasticizer | | | Butvar B-72 | 0.2% | | |

*Corning Code 7761 borosilicate glass powder (78.56% SiO₂, 18.58% B₂O₃, 2.77% K₂O, 0.09% AL₂O₃)

Each of these mixtures is useful for plugging selective channels in aluminum titanate ceramic honeycomb structures to be converted to ceramic wall flow filter bodies of aluminum titanate composition, when blended with a water vehicle to develop a paste-like consistency. In the case of cold-set plugging mixtures, exemplified by Mixture A above, the paste mixture is simply introduced into the ends of selected channels of an aluminum titanate honeycomb body and the plugged body then dried in an oven at about 100° F. for two hours to drive off the excess water in the plugs. The cordierite refractory filler used in the mixture has an average linear coefficient of thermal expansion of about 15×10⁻⁷/° C. over the temperature range 25-800° C., such that the plugs are physically compatible with the aluminum titanate honeycomb of the filter body from the standpoint of expansion matching, as well as exhibit good high-temperature composition stability.

Similarly, aluminum titanate honeycombs plugged with either of plugging Mixtures B and C above, converted to pastes by an appropriate water addition, will exhibit favorable plug stability, strength and sealing characteristics. In the case of Mixture B, for example, which is representative of a useful heat-curable composition, the plugged body may be heated to a drying temperature as in the case of cold-set Mixture A above, and then thereafter further heated to a curing temperature of up to 1000° C. In that case curing will fully activate the permanent bonding agent and thereby immediately consolidate and seal the plugs to the porous aluminum titanate ceramic walls of the honeycomb structure.

### Example 3

### Mixed Powder-Filled Plugging Mixtures

Further examples of powder filled plugging mixtures wherein combinations of powders are employed to modify plug properties are reported in Table 3 below, in parts by weight of the final plugging mixtures. The mixed refractory fillers consisted of cordierite powders in two different mean particle sizes of 40 microns and 12 microns.

TABLE 3
Mixed Filler Plugging Mixtures

| | | Mixture D | Mixture E |
|---|---|---|---|
| Refractory filler(s) | Cordierite powder (40 um); | 50 | 30 |
| | Cordierite powder (12 um): | 30 | 50 |
| Permanent bonding | Ludox ® HS40 colloidal | 25 | 25 |
| agent(s) | silica Borosilicate glass | 20 | 20 |
| | powder* | | |
| Temporary binder | Methocel ® A4M cellulose | 1 | 2 |
| | ether | | |
| Optional lubricant(s) | Stearic acid; | — | 0.6 |
| | Durasyn ® 162 oil | — | 6 |
| Vehicle | Water | 20 | 32 |

*Corning Code 7740 borosilicate glass powder

These plugging mixtures are particularly well suited for the plugging of aluminum titanate honeycomb bodies. The sample E mixture exhibits improved lubricity for the plugging of ceramic honeycombs at reduced plugging pressures.

We claim:

1. A plugging mixture for a ceramic wall flow filter comprising:
a low-expansion refractory filler;
a permanent inorganic bonding agent;
a liquid vehicle; and
a vehicle-soluble temporary binder.

2. A plugging mixture in accordance with claim 1 wherein the liquid vehicle is water and the temporary binder is a water-soluble cellulosic binder.

3. A plugging mixture in accordance with claim 1 wherein the refractory filler is selected from the group consisting of aluminosilicate fibers and powders of silicon carbide, silicon nitride, cordierite, aluminum titanate, calcium aluminate, beta-eucryptite, and beta-spodumene.

4. A plugging mixture in accordance with claim 2 wherein the permanent inorganic bonding agent is powdered silica or a silicate glass.

5. A plugging mixture in accordance with claim 1 which further includes a lubricant or a plasticizer.

6. A plugging mixture in accordance with claim 1 wherein the weight ratio of the permanent inorganic bonding agent to the refractory filler is in the range from 1:20 to 2:3.

7. A porous ceramic wall flow filter body comprising a ceramic honeycomb structure incorporating a plurality of parallel channels bounded by porous ceramic channel walls, with selected channels incorporating plugs permanently sealed to the channel walls, wherein the plugs comprise a low-expansion refractory filler and a permanent inorganic bonding agent that consolidates the refractory filler into plugs and seals the plugs to the channel walls.

8. A porous ceramic wall flow filter body in accordance with claim 7 which has a composition that includes a ceramic selected from the group consisting of cordierite, silicon carbide, silicon nitride, aluminum titanate, beta-eucryptite, and beta-spodumene.

9. A porous ceramic wall flow filter body in accordance with claim 8 wherein the plugs contain a low expansion refractory ceramic filler selected from the group consisting of aluminosilicate fibers and powders of silicon carbide, silicon nitride, cordierite, aluminum titanate, calcium aluminate, beta-eucryptite, and beta-spodumene, and further contain a permanent inorganic bonding agent selected from the group consisting of powdered silica and silicate glass.

10. A porous ceramic wall flow filter body in accordance with claim 9 wherein the weight ratio of the permanent inorganic bonding agent to the refractory filler is in the range from 1:20 to 2:3.
